(19) United States
(12) Patent Application Publication
(10) Pub. No.: US 2025/0286067 A1
(43) Pub. Date: Sep. 11, 2025

(54) COMPOSITE PARTICLES FOR NEGATIVE ELECTRODES, METHODS OF PREPARATION THEREOF, AND LITHIUM-ION BATTERIES COMPRISING THE SAME

(71) Applicants: Hyundai Motor Company, Seoul (KR); Kia Corporation, Seoul (KR)

(72) Inventor: Sangha Lee, Hwaseong (KR)

(21) Appl. No.: 19/070,195

(22) Filed: Mar. 4, 2025

(30) Foreign Application Priority Data
Mar. 5, 2024 (KR) 10-2024-0031138

(51) Int. Cl. H01M 4/62; H01M 4/02; H01M 4/133; H01M 4/587; H01M 10/0525

(52) U.S. Cl. CPC H01M 4/622; H01M 4/133; H01M 4/587; H01M 4/625; H01M 10/0525; H01M 2004/027

(57) ABSTRACT

This disclosure relates to a composite particle for a negative electrode in lithium secondary batteries. The composite includes a polymer with functional groups such as hydroxy, carboxyl, acrylate, amine, amide, or imide, and a rubber containing an epoxy group. These components are cross-linked and combined with an active material like silicon or silicon oxide. The composite may also incorporate conductive materials like carbon nanotubes or graphite. The preparation method involves pretreating rubber, forming a slurry with the polymer, active material, and conductive material, and then spray drying. This composite is used to enhance the performance of negative electrodes in lithium batteries.

### CROSS-REFERENCE TO RELATED APPLICATION

This application claims under 35 U.S.C. § 119(a) the benefit of Korean Patent Application No. 10-2024-0031138 filed in the Korean Intellectual Property Office on Mar. 5, 2024, the entire contents of which are incorporated herein by reference.

### BACKGROUND

### Technical Field

The present disclosure relates to a composite particle for a negative electrode, a manufacturing method thereof, and a lithium secondary battery including the same. More specifically, it relates to a cross-linked composite particle for a negative electrode, a manufacturing method thereof, and a lithium secondary battery including the same.

### Background

Recently, the demand for rechargeable batteries, which are used to repeatedly charge and discharge as a power source for portable electronic devices such as mobile phones and laptops, and electric bicycles and electric vehicles, has been increasing exponentially. Lithium secondary batteries currently on the market mainly use LiCoO₂ for the positive electrode and carbon for the negative electrode.

Currently, the most commonly used negative electrode material for rechargeable batteries is graphite. A graphite has a very regular structure and is composed of several layers of carbon bonded together. When charging, lithium ions move from the positive electrode to the negative electrode and enter between the graphite layers, causing the lithium ions to expand slightly. Over time, there is a problem where the structure is degraded and the structure collapses, and the battery lifespan gradually decreases accordingly.

Silicon is the most commonly used material following graphite. Silicon has an energy density about 10 times higher than that of graphite and offers fast charge and discharge speeds, but like graphite, silicon also suffers from poor stability due to volume expansion.

The next generation battery uses lithium metal, which is advantageous for increasing energy capacity. Lithium metal easily reacts with moisture or oxygen in the atmosphere to form hydroxide or oxide. Therefore, while being used as a rechargeable battery negative electrode material, air-tightness must be maintained to avoid contact with moisture or oxygen. In particular, since the heat of reaction generated during the lithium hydroxide or oxide formation reaction is very high, there is a problem that it may cause a fire in a rechargeable battery pack or a mobile device or electric vehicle powered by a rechargeable battery.

Accordingly, there is a need for the development of composite particles for negative electrodes to improve the stability and lifespan of lithium secondary batteries.

### SUMMARY OF THE DISCLOSURE

The embodiment of the present disclosure is to provide a composite particle for a negative electrode that can improve the energy density of lithium secondary batteries.

Another embodiment of the present disclosure is to provide a composite particle manufacturing method for negative electrodes that has the above-described advantages.

The embodiment of the present disclosure is to provide a composite particle for negative electrode, comprising:
a polymer containing at least one or more functional groups selected from hydroxy group, carboxyl group, acrylate group, amine group, amide group and imide group; a rubber containing an epoxy group; and an active material comprising at least one of silicon or silicon oxide; wherein, the polymer and the rubber are cross-linked.

The total content of the polymer and rubber may be 5 to 30 wt %, based on the entire composite particle for negative electrode.

The weight ratio of polymer to the rubber can be 10:90 to 50:50. The weight ratio can be about 20:80 to 40:60.

The content of the active material may be 50 to 97 wt %, based on the entire composite particle for negative electrode.

The active material may additionally include graphite.

The composite particles for the negative electrode additionally include a conductive material, and the conductive material may include one or more types selected from carbon nanotube, carbon black, and graphite.

The average particle diameter D50 of the composite particle for the negative electrode may be 1 to 20 μm.

The polymer may include at least one polymer selected from chitosan, sodium carboxylmethylcellulose (CMC), polyacrylic acid (PAA), and polyamide-imide (PAI).

The polymer may be chitosan.

The weight average molecular weight Mw (or number average molecular weight Mn) of the polymer may be 50,000 to 350,000 Da.

The rubber may include one or more selected from styrene butadiene rubber, natural rubber, nitrile rubber, isoprene rubber, and fluorine rubber.

The composite particle for the negative electrode is a matrix in which one or more functional groups positioned on the polymer and an epoxy group positioned on the rubber are cross-linked; and silicon particles positioned within the matrix.

The content of the silicon may be more than 30 wt % of the composite particle entire 100 wt % reference for the negative electrode.

Another embodiment of the present disclosure is to provide a method of preparing a composite particle for a negative electrode, comprising:

pretreating a rubber; manufacturing a slurry by distributing the pretreated rubber, a polymer, an active material, and a conductive material in a solvent; and spraying and drying the slurry.

The step of pretreating the rubber includes mixing rubber, hydrogen peroxide, formic acid, and surfactant; heating and washing the mixed material.

The drying temperature of the spray drying stage can be 120 to 250° C.

The size of the droplets in the spray drying step can be 1 to 30 μm.

Another embodiment of the present disclosure is to provide a negative electrode, comprising:

a negative electrode current collector; and a negative active material layer formed on the negative electrode current collector, wherein, the negative active material layer includes a composite particle for a negative electrode according to the embodiment.

Another embodiment of the present disclosure is to provide a lithium secondary battery, comprising:

a negative electrode according to the embodiment; a positive electrode opposite the negative electrode; a separator disposed between the negative electrode and the positive electrode; and an electrolyte.

The composite particle for a negative electrode according to one embodiment of the present disclosure can improve the capacity of the battery by being included in the negative electrode of a lithium secondary battery.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 is a scanning electron microscope (SEM) image of a composite particle for a negative electrode according to some embodiments of the present disclosure.

### DETAILED DESCRIPTION OF THE EMBODIMENTS

Terms such as first, second and third are used to describe, but are not limited to, the various parts, components, region, layers and/or sections. These terms are used only to distinguish one part, component, region, layer, or section from another part, component, area, layer, or section. Accordingly, a first part, component, region, layer or section described herein may be referred to as a second part, component, region, layer or section without departing from the scope of the present disclosure.

The technical terms used herein are intended to refer only to certain exemplary embodiments and are not intended to limit the present disclosure. The singular forms used here include plural forms unless the context clearly indicates the opposite. The meaning of “comprising/including/containing/having” as used in a specification is to specify a particular characteristic, region, integer, step, behavior, element, and/or component, and does not exclude the existence or added any other characteristic, region, integer, step, behavior, element, and/or component.

When we say that a part is “on” or “above” another part, it may be directly on or above the other part, or it may entail another part in between. In contrast, when we say that something is “directly on” of something else, we don't interpose anything between them.

Unless otherwise defined, all terms used herein, including technical and scientific terms, have the same meaning as commonly understood by a person of ordinary skill in the technical field to which the present disclosure belongs. Commonly used dictionary-defined terms are further construed to have meanings consistent with the relevant technical literature and the present disclosure and are not to be construed in an idealized or highly formal sense unless defined.

Also, unless otherwise noted, “%” refers to “wt %”, where 1 ppm is 0.0001 wt %.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In this specification, the term “combination thereof(s)” described in a Markush format expression means one or more mixtures or combinations selected from the group consisting of components described in the Markush format expression and means including one or more selected from the group consisting of the components.

Below, an embodiment is described in detail so that a person of ordinary skill in the technical field to which the present disclosure belongs can easily carry out the present disclosure. As those skilled in the art would realize, the described embodiments may be modified in various different ways, all without departing from the spirit or scope of the present disclosure.

### 1. Composite Particle for Negative Electrode

The embodiment of the present disclosure is to provide a composite particle for negative electrode, comprising:

a polymer containing at least one or more functional groups selected from hydroxy group, carboxyl group, acrylate group, amine group, amide group and imide group; a rubber containing an epoxy group; and an active material comprising at least one of silicon or silicon oxide; wherein, the polymer and the rubber are cross-linked. It is preferable to select a polymer that has excellent resistance to volume expansion/contraction of the silicon-based active material and can impart strong stress. In the case of composite particles for the negative electrode, specific functional groups included in the polymer and specific functional groups included in the rubber within the negative electrode can form a cross-linking structure with each other. Through this cross-linking structure, the composite particle for the negative electrode can maintain an appropriate level of strong stress within the negative electrode while improving the flexibility of the negative electrode to an excellent level. When the composite particle for the negative electrode is applied to the negative electrode together with the active material, the lifespan performance of the lithium secondary battery can be improved while controlling the volume expansion/contraction of the active material to a desirable level. The active material may be an active material including at least one selected from the group consisting of silicon and silicon oxide, but is not limited thereto, and any material that can be used as a negative active material may be used.

In the composite particle for a negative electrode according to an embodiment, the total content of the polymer and rubber may be 5 to 30 wt % with respect to the entire composite particle for a negative electrode as a reference, specifically 5 to 25 wt %, and more specifically 5 to 20 wt % or 5 to 15 wt %. If the total content of the polymer and rubber satisfies the range, there may be an advantage of improving the lifespan of the battery. On the other hand, if the total content of the polymer and rubber is less than 5 wt %, the durability performance may be significantly reduced, and if the total content of the polymer and rubber exceeds 30 wt %, the composition of the active material may be reduced, which may cause a problem of reduced battery capacity.

In a composite particle for a negative electrode according to an embodiment, the weight ratio of polymer to rubber may be 10:90 to 50:50, and specifically 20:80 to 40:60. If the weight ratio of the rubber and polymer satisfies the range, there may be an advantage in that the capacity per volume of the battery may increase. On the other hand, if the rubber content is less than 10, the cushioning effect of the rubber may decrease, which may reduce the lifespan of the battery. If the rubber content exceeds 50, the properties of the cross-linked rubber-polymer supporter become too soft, and the structure of the composite particle for the negative electrode is not maintained, which may cause a significant decrease in the initial performance of the battery. In addition, when the polymer content exceeds 90 and the polymer is included in the composite particle composition for the negative electrode, the volume expansion control of the negative active material may be difficult when applied to the negative electrode due to excessive increase in flexibility, and the stability of the composite particle for the negative electrode may be deteriorated and phase separation may occur, which may cause a problem in that the flexibility of the cross-linking network is deteriorated.

In a composite particle for a negative electrode according to an embodiment, the content of the active material may be 50 to 97 wt % with respect to the entire composite particle for a negative electrode as a reference, and specifically, may be 60 to 90 wt %. If the content of the active material satisfies the range, there may be an advantage in improving the discharge capacity and charge/discharge efficiency of the battery. On the other hand, if the content of the active material is less than 50 wt %, there may be a problem of the battery's energy density decreasing. If the content of the active material exceeds 97 wt %, the content of the cross-linked rubber polymer decreases, which may result in a problem in which the lifespan of the battery is reduced due to a decrease in the stress relief effect.

In a composite particle for a negative electrode according to an embodiment, the active material may additionally include graphite. If graphite is additionally included in the active material, the volume expansion rate of the active material can be reduced, thereby improving the performance of the battery.

In a composite particle for a negative electrode according to an embodiment, the composite particle for the negative electrode additionally includes a conductive material, and the conductive material may include at least one selected from carbon nanotube, carbon black, and graphite.

In a composite particle for a negative electrode according to an embodiment, the average particle diameter D50 of the composite particle for a negative electrode may be 1 to 20 μm and specifically may be 3 to 15 μm. If the average particle diameter D50 of the composite particle for the negative electrode satisfies the range, there may be an advantage of improving the charge/discharge efficiency of the battery. On the other hand, if the average particle diameter D50 of the composite particle for the negative electrode is less than 1 μm, there may be a problem in that the amount of binder and conductive material required for electrode production increases. If the average particle diameter D50 of the composite particle for the negative electrode exceeds 20 μm, the deviation of the particle size may increase, which may result in a decrease in the durability performance of the electrode.

In a composite particle for a negative electrode according to an embodiment, the polymer may include at least one polymer selected from chitosan, carboxylmethylcellulosesodium (CMC), polyacrylic acid (PAA), and polyamide-imide (PAI). The polymer may contain a functional group capable of crosslinking with rubber.

In a composite particle for a negative electrode according to an embodiment, the polymer may be chitosan.

The weight average molecular weight Mw (or number average molecular weight Mn) of the polymer can be 50,000 to 350,000 Da, specifically 75,000 to 325,000 Da, and more specifically 100,000 to 300,000 Da or 125,000 to 275,000 Da. When the weight average molecular weight satisfies the range, it can form a cross-linking network with rubber as a polymer binder and exhibit strong physical characteristics. On the other hand, if the weight average molecular weight is out of the range, cross-linking between the polymer and rubber may not occur well, which may result in the supporter's physical properties becoming too soft, or volume expansion control of the negative active material may be difficult when applying the negative electrode.

In a composite particle for a negative electrode according to an embodiment, the rubber may include at least one selected from styrene butadiene rubber, natural rubber, nitrile rubber, isoprene rubber, and fluorine rubber. The rubber may contain a functional group capable of crosslinking with the polymer.

In a composite particle for a negative electrode according to an embodiment, the composite particle for the negative electrode may include a matrix in which one or more functional groups positioned on the polymer are cross-linked with an epoxy group positioned on the rubber; and a silicon particle positioned within the matrix. Although silicon particles exhibit higher capacity than carbon-based active materials, there may be problems with large volume expansion and shrinkage due to charging and discharging. However, since the composite particle for the negative electrode described above can simultaneously provide excellent stress and flexibility to the negative electrode when used in the negative electrode, the volume expansion control of the silicon particle can be smoothly achieved, while the problems of damage to the active material due to excessive stress, distortion, and warping of the negative electrode can be resolved.

In a composite particle for a negative electrode according to an embodiment, the silicon content may be 30 wt % or more of the composite particle for a negative electrode entire 100 wt % reference, and specifically 50 to 97 wt %. If the silicon content satisfies the range, there may be an advantage in improving the battery's discharge capacity and charge and discharge efficiency. On the other hand, if the silicon content is out of the range, the energy density of the battery may decrease, or the stress relief effect may decrease due to a decrease in the content of the cross-linked rubber polymer, which may lower the lifespan of the battery.

### 2. Composite Particle Manufacturing Method for Negative Electrode

A method for manufacturing a composite particle for a negative electrode according to another embodiment of the present disclosure comprises the steps of pretreating rubber; distributing the pretreated rubber, polymer, active material and conductive material into a solvent to manufacture slurry; and spray drying the slurry.

In the step of spray drying the slurry, the spraying device may use an ultrasonic wave and nozzle spraying device, but is not limited thereto, and any device capable of spray drying the slurry, such as a one-fluid and two-fluid air nozzle spraying device, a filter expansion droplet generating device (FEAG), and a disk type droplet generating device, may be used.

In a method for manufacturing a composite particle for a negative electrode according to another embodiment of the present disclosure, the step of pretreating rubber may include a step of mixing rubber, hydrogen peroxide, formic acid, and surfactant; and a step of heating and washing the mixed material.

In a composite particle manufacturing method for a negative electrode according to another embodiment of the present disclosure, the spray speed of the spray drying step can be 5 to 50 L/min, specifically 10 to 45 L/min, more specifically 15 to 40 L/min or 20 to 35 L/min, and the spray speed can be changed depending on the shape of the nozzle and the concentration of the solution.

In a method for manufacturing a composite particle for a negative electrode according to another embodiment of the present disclosure, the drying temperature of the spray drying step can be 120 to 250° C. When the drying temperature satisfies the range, cross-linking of rubber and polymer can occur, forming a rubber-polymer supporter. On the other hand, if the drying temperature is less than 120° C., crosslinking between the rubber and the polymer may not occur, and if the drying temperature is more than 250° C., there may be a problem of decomposition between the rubber and the polymer.

In a method for manufacturing a composite particle for a negative electrode according to another embodiment of the present disclosure, the size of the droplets in the spray drying step can be 1 to 30 μm, and specifically 5 to 25 μm. If the size of the droplet satisfies the range, the size of the particle can be appropriately controlled. On the other hand, if the size of the droplets is less than 1 μm, the size of the generated particles may be too small to be used as a negative active material. In addition, when the droplet size is 30 μm or smaller, the size of the generated particles increases, and at the same time, the size of the particles may be non-uniform.

### 3. Lithium Secondary Battery

Another embodiment of the present disclosure comprises a negative electrode current collector; and a negative active material layer formed on the negative electrode current collector; wherein the negative active material layer comprises a negative electrode formed of negative electrode slurry including composite particles for the negative electrode as described above.

The lithium rechargeable battery may more specifically include a positive electrode, a negative electrode positioned opposite the positive electrode, a separator interposed between the positive electrode and the negative electrode, and an electrolyte.

Since the negative electrode is as described above, the remaining components are described in detail below.

The negative electrode may include a current collector, and a negative active material layer formed on the current collector and including the negative active material according to an embodiment.

The negative active material includes a material capable of intercalating/deintercalating lithium ions reversibly, lithium metal, an alloy of lithium metal, a material capable of doping and undoping lithium, or a transition metal oxide.

A material that can intercalate/deintercalate the lithium ion reversibly is a carbon material, any generally-used carbon-based negative active material can be used in a lithium-ion secondary battery, and typical examples thereof include crystalline carbon, amorphous carbon or combination thereof.

The alloy of the lithium metal is from the group consisting of lithium and Na, K, Rb, Cs, Fr, Be, Mg, Ca, Sr, Si, Sb, Pb, In, Zn, Ba, Ra, Ge, Al and Sn. Any alloy of selected metals may be used.

Materials capable of doping and undoping the lithium include Si, SiOx (0<x<2), Si—Y alloy (the Y is an element selected from the group consisting of an alkali metal, an alkaline earth metal, a group 13 element, a group 14 element, a transition metal, and a rare earth element and its combination thereof, but not Si), Sn, SnO₂, Sn—Y (the Y is an element selected from the group consisting of an alkali metal, an alkaline earth metal, a group 13 element, a group 14 element, a transition metal, a rare earth element and the combination thereof, not Sn), and the like.

Examples of the transition metal oxide include vanadium oxide and lithium vanadium oxide. The negative active material layer also includes a binder and may optionally further include a conductive material.

The binder serves to adhere the negative active material particles to each other well and to adhere the negative active material to the current collector well.

The conductive material is used to impart conductivity to the electrode, and any electronic conductive material can be used without causing chemical change in the battery.

As the current collector, one selected from the group consisting of copper foil, nickel foil, stainless steel foil, titanium foil, nickel foam, copper foam, a conductive metal-coated polymer substrate, and a combination thereof may be used.

The negative electrode may be prepared by preparing a composition for forming a negative electrode active material layer by mixing the negative electrode active material prepared according to an embodiment, a binder, and optionally a conductive material, and then applying the composition to the negative electrode current collector.

The solvent that can be used is N-methylpyrrolidone but is not limited thereto.

The electrolyte can be a non-aqueous electrolyte or a solid electrolyte, and one containing dissolved lithium salt is used.

The non-aqueous electrolyte may contain an organic solvent, and the non-aqueous organic solvent may act as a medium through which ions involved in the electrochemical reactions of the battery can move.

As the organic solvent, for example, cyclic carbonates such as ethylene carbonate, propylene carbonate, butylene carbonate, and vinylene carbonate; chain carbonates, such as dimethyl carbonate, methyl ethyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitriles such as acetonitrile; amides such as dimethylformamide may be used, but is not limited thereto. These may be used alone or in combination of a plurality of them. Particularly, a mixed solvent of cyclic carbonate and chain carbonate can be preferably used.

Also, as an electrolyte, a gel polymer electrolyte impregnated with an electrolyte solution in a polymer electrolyte such as polyethylene oxide or polyacrylonitrile, or an inorganic solid electrolyte such as LiI or Li₃N is possible.

The lithium salt is a material that dissolves in an organic solvent and acts as a source of lithium ions within the battery, enabling the basic operation of a lithium secondary battery and promoting the movement of lithium ions between the positive electrode and the negative electrode.

The lithium salt may be applied without limitation to any salt commonly used in the art, as long as it does not interfere with the purpose of the present disclosure. The lithium salt may use, for example, at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiCl, and LiI.

Depending on the type of lithium secondary battery, a separator may exist between the positive and negative electrodes. As such separators, polyethylene, polypropylene, polyvinylidene fluoride or multilayers of two or more layers thereof can be used, and mixed multilayers such as a polyethylene/polypropylene two-layer separator, a polyethylene/polypropylene/polyethylene three-layer separator, or a polypropylene/polyethylene/polypropylene three-layer separator can also be used.

Lithium secondary batteries can be classified into lithium-ion batteries, lithium ion polymer batteries, and lithium polymer batteries depending on the type of separator and electrolyte used, and can be classified into cylindrical, square, coin-type, pouch-type, etc. depending on the shape, and can be divided into bulk type and thin film type depending on the size.

The present disclosure does not limit the structure and manufacturing method of the lithium secondary battery.

As described above, a lithium secondary battery including a positive active material according to the present disclosure stably exhibits excellent discharge capacity, output characteristics, and charge and discharge efficiency, and is therefore useful in portable devices such as portable telephones, laptop computers, and digital cameras, and electric vehicles such as hybrid electric vehicles (HEVs).

Accordingly, another embodiment of the present disclosure provides a battery module including the lithium secondary battery as a unit cell and a battery pack including the same.

The battery module or battery pack can be used as a power source for one or more medium- to large-sized devices, including a power tool; an electric vehicle (EV), a hybrid electric vehicle, and a plug-in hybrid electric vehicle (PHEV); or an electric power storage system.

Below, an implementation example of the present disclosure is described in more detail through embodiment. However, the following embodiment is only a preferable embodiment, and the present disclosure is not limited by the following embodiment.

### Preparation Example 1

An aqueous solution containing 50 g of SBR rubber was mixed with 15 g of hydrogen peroxide, 10 g of formic acid, and 5 g of surfactant, heated at 70° C. for 1 hour, and then washed to produce a rubber containing an epoxy functional group as an adhesive material.

### Embodiment 1

### 1) Manufacturing Composite Particles for Negative Electrode

Mw 150,000 polymer was used as a polymer. The polymer was prepared by distributing 90 wt % of the rubber in preparation Example 1, silicon (average particle diameter D50: 50 to 100 nm) and 10 wt % of the conductive material into a solvent. The solvent used was an aqueous solution containing 2 wt % of acetic acid, and the weight ratio of the rubber and polymer used was 30:70, and the mixture was stirred for 12 hours to prepare a slurry. The slurry was spray dried at a spray speed of 50 L/min to produce composite particles for the negative electrode. The polymer and the rubber in the composite particle for the negative electrode were cross-linked to each other.

### 2) Manufacturing Negative Electrode

Electrode slurry was prepared by mixing 95 wt % of composite particles for negative electrode, 1 wt % of carbon black, 0.5 wt % of CMC (Carboxy methyl cellulose), and 1 wt % of SBR (Styrene-Butadiene Rubber) with an appropriate amount of N-Methyl-2-pyrrolidone solvent. The electrode slurry was coated with a copper current collector and then heated and rolled to obtain a negative electrode.

### 3) Preparation of Battery

After stacking the negative electrode/separator/lithium metal in that order, an electrolyte containing 1:1 ethylenecarbonate (EC)/dimethylcarbonate (DMC) and 1M LiPF₆ was injected to manufacture a coin cell, and then a battery was manufactured through a chemical process that performs aging and charge and discharge.

### Embodiment 2

It was manufactured using the same method as embodiment 1, except that 5 wt % of conductive material and 5 wt % of adhesive material were added.

### Embodiment 3

It was manufactured using the same method as embodiment 1, except that 85 wt % of silicon and 5 wt % of adhesive material were added.

### Embodiment 4

It was manufactured using the same method as embodiment 1, except that 80 wt % of silicon and 10 wt % of adhesive material were added.

### Embodiment 5

It was manufactured using the same method as embodiment 1, except that 75 wt % of silicon and 15 wt % of adhesive material were added.

### Embodiment 6

It was manufactured using the same method as embodiment 1, except that it contained 80 wt % of silicon, 10 wt % of adhesive material, and the weight ratio of rubber and polymer was 10:90.

### Embodiment 7

It was manufactured using the same method as embodiment 1, except that it contained 80 wt % of silicon, 10 wt % of adhesive material, and the weight ratio of rubber and polymer was 20:80.

### Embodiment 8

It was manufactured using the same method as embodiment 1, except that it contained 80 wt % of silicon, 10 wt % of adhesive material, and the weight ratio of rubber and polymer was 40:60.

### Embodiment 9

It was manufactured using the same method as embodiment 1, except that it contained 80 wt % of silicon, 10 wt % of adhesive material, and the weight ratio of rubber and polymer was 50:50.

### Embodiment 10

It was manufactured using the same method as embodiment 1, except that 24 wt % of silicon, 56 wt % of graphite, and 10 wt % of adhesive material were added.

### Comparative Example 1

### 1) Active Material

A silicon active material of 100 nm size was prepared.

### 2) Preparation of Negative Electrode

Electrode slurry was prepared by mixing 0.5 wt % of the silicon active material, CMC (Carboxy methyl cellulose), and 1 wt % of SBR (Styrene-Butadiene Rubber) with an appropriate amount of N-Methyl-2-pyrrolidone solvent. The electrode slurry was coated with a copper current collector and then heated and rolled to obtain a negative electrode.

### 3) Preparation of Battery

It was manufactured in the same manner as the battery manufacturing method of embodiment 1, except that the negative electrode manufactured in Comparative Example 1 was used.

### Comparative Example 2

### 1) Active Material

A silicon active material of 100 nm size was prepared.

### 2) Preparation of Negative Electrode

Electrode slurry was prepared by mixing the silicon active material, rubber-polymer crosslinking binder, and an appropriate amount of N-Methyl-2-pyrrolidone solvent. The electrode slurry was coated with a copper current collector and then heated and rolled to obtain a negative electrode. The rubber used is the rubber of Preparation Example 1, and the weight ratio of rubber and polymer is 30:70.

### 3) Preparation of Battery

It was manufactured in the same manner as the battery manufacturing method of embodiment 1, except that the negative electrode manufactured in Comparative Example 1 was used.

### Experimental Example 1: Composite Particle SEM Image Analysis for Negative Electrode

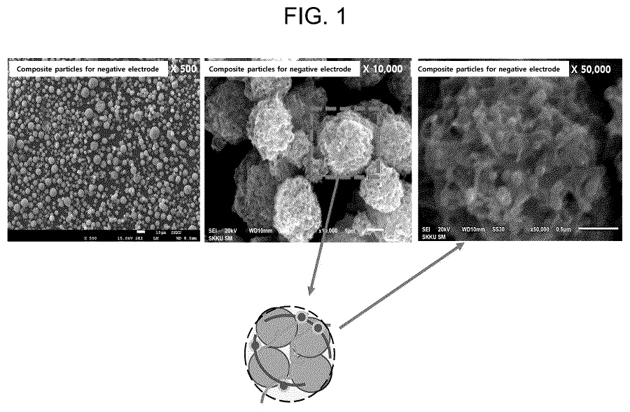

This is a scanning electron microscope (SEM) image of a composite particle for a negative electrode manufactured according to embodiment 1. Scanning electron microscope images of the composite for the negative electrode in FIG. 1 were measured at ×500 (left), ×10,000 (middle), and ×50,000 (right) scales. The image measurement result is a spherical shaped particle, and referring to the image of ×50,000 (left), it can be confirmed that several materials are included within the composite particle for the negative electrode.

### Experimental Example 2: Evaluation of Electrochemical Characteristics of Lithium Secondary Battery

### 1) Initial Capacity Evaluation

After fabricating a lithium secondary battery half-cell according to the embodiment and comparative example, the cell was aged at 25° C. for 4 hours and then charge and discharge tests were performed at 25° C. To evaluate the initial capacity, 1,000 mAh/g was used as the reference capacity, and charging was performed at a constant current of 1.0 C until the voltage reached 2.5 V. After a rest time of 10 minutes after charging, discharge was performed at a constant current of 1.0C with 1,000 mAh/g as the reference capacity until 0 V was reached, and the initial capacity is shown in Table 1 below.

### 2) Lifespan Characteristic Evaluation (25° C., 100 Cycle)

The lifespan characteristics of the lithium secondary battery manufactured according to the embodiment and comparative example were evaluated using the following method, and the results are shown in the following Table 1.

After fabricating a lithium secondary battery half-cell, it was left to rest for 12 hours and then charged at a constant current of 1.0C at 25° C. until it reached 2.5 V. After a 10-minute rest period after charging, discharge was performed at a constant current of 1.0 C until reaching 0 V. Charge and discharge were performed 100 times under the above charge and discharge cycle conditions, and the capacity retention of the 100th cycle was calculated compared to the first cycle.

TABLE 1

| | Composite particle for negative electrode | | | | | Preparation | | | |
|---|---|---|---|---|---|---|---|---|---|
| | | | | Adhesive | rubber | of | | | |
| | | | | material | and | electrode | performance | | |
| | | | conductive | (Preparation | polymer | binder | volume | volume@ | lifespan |
| | Silicon | Graphite | material | Example1) | weight | type | @1 cycle | 100cycle | reduction |
| | (%) | (%) | (%) | (%) | ratio | (ratio) | (mAh) | (mAh) | (mAh/cycle) |
| Comparative | silicon 100% | | | | | CMC/S | 1560 | 217 | −13.43 |
| Example 1 | | | | | | BR 1:2 | | | |
| Comparative | silicon 100% | | | | | rubber- | 1720 | 251 | −14.69 |
| Example 2 | | | | | | polymer | | | |
| | | | | | | 3:7 | | | |
| embodiment 1 | 90 | — | 10 | 0 | 30:70 | CMC/S | 981 | 181 | −7.99 |
| embodiment 2 | 90 | — | 5 | 5 | 30:70 | BR 1:2 | 1333 | 415 | −9.18 |
| embodiment 3 | 85 | — | 10 | 5 | 30:70 | | 1515 | 403 | −11.12 |
| embodiment 4 | 80 | — | 10 | 10 | 30:70 | | 1261 | 782 | −4.49 |
| embodiment 5 | 75 | — | 10 | 15 | 30:70 | | 1207 | 731 | −4.76 |
| embodiment 6 | 80 | — | 10 | 10 | 10:90 | | 1385 | 441 | −9.44 |
| embodiment 7 | 80 | — | 10 | 10 | 20:80 | | 1201 | 648 | −5.53 |
| embodiment 8 | 80 | — | 10 | 10 | 40:60 | | 997 | 572 | −4.25 |
| embodiment 9 | 80 | — | 10 | 10 | 50:50 | | 911 | 514 | −3.97 |
| embodiment 10 | 24 | 56 | 10 | 10 | 30:70 | | 650 | 554 | −0.96 |

Referring to Table 1, although the initial capacity of embodiments 1 to 10 was not as large as that of Comparative Example 1, the capacity retention after 100 charging and discharging cycles was confirmed to be higher than that of Comparative Example 1, and the lifespan reduction effect was also confirmed to be improved compared to Comparative Example 1. In addition, it was confirmed that the lifespan of the battery was significantly improved when the rubber ratio among the weight ratios of rubber and polymer in the embodiment was 20 or more. In addition, when silicon and graphite composite were used as the active material in embodiment 10, the initial capacity was not high, but it was confirmed that the capacity retention after 100 charging and discharging cycles was higher than that of Comparative Example 1, and the lifespan reduction effect was also confirmed to be improved compared to that of Comparative Example. This may be because the use of a silicon/graphite composite lowers the volume expansion rate of the active material, resulting in an improved lifespan. Although the preferred embodiment of the present disclosure has been described above, the present disclosure is not limited thereto, and it is possible to implement the present disclosure by making various modifications within the scope of the patent claims and the detailed description and accompanying drawings of the disclosure, and this also naturally falls within the scope of the present disclosure.

What is claimed is:

1. A composite particle for negative electrode, the composite comprising:
a polymer comprising at least one or more functional groups selected from hydroxy group, carboxyl group, acrylate group, amine group, amide group and imide group;
a rubber comprising an epoxy group; and
an active material comprising at least one of silicon or silicon oxide;
wherein the polymer and the rubber are cross-linked.

2. The composite particle of claim 1, wherein:
a total content of the polymer and rubber is about 5 to 30 wt % based on the entire composite particle for negative electrode.

3. The composite particle of claim 2, wherein:
a weight ratio of the polymer to the rubber is about 10:90 to 50:50.

4. The composite particle of claim 3, wherein:
the weight ratio is about 20:80 to 40:60.

5. The composite particle of claim 1, wherein:
a content of the active material is about 50 to 97 wt %, based on the entire composite particle for negative electrode.

6. The composite particle of claim 5, wherein:
the active material further comprises a graphite.

7. The composite particle of claim 1, wherein:
the composite particle for the negative electrode further comprises a conductive material, and
the conductive material comprises one or more selected from carbon nanotube, carbon black, and a graphite.

8. The composite particle of claim 1, wherein:
an average particle diameter D50 of the composite particle for the negative electrode is about 1 to 20 μm.

9. The composite particle of claim 1, wherein:
the polymer comprises at least one polymer selected from chitosan, carboxylmethylcellulose sodium (CMC), polyacrylic acid (PAA), and polyamide-imide (PAI).

10. The composite particle of claim 1, wherein:
the polymer is chitosan.

11. The composite particle of claim 1, wherein:
a weight average molecular weight Mw (or number average molecular weight Mn) of the polymer is about 50,000 to 350,000 Da.

12. The composite particle of claim 1, wherein:
the rubber comprises one or more selected from styrene butadiene rubber, natural rubber, nitrile rubber, isoprene rubber, and fluorine rubber.

13. The composite particle of claim 1, wherein:
the composite particle for the negative electrode further comprises:
a matrix in which one or more functional groups positioned on the polymer and an epoxy group positioned on the rubber are cross-linked; and
a silicon particle positioned within the matrix.

14. The composite particle of claim 13, wherein:
a content of silicon is at least 30% by weight based on the entire composite particle for the negative electrode being 100% by weight.

15. A method of preparing a composite particle for a negative electrode, comprising:
pretreating a rubber;
manufacturing a slurry by distributing the pretreated rubber, a polymer, an active material, and a conductive material in a solvent; and
spraying and drying the slurry.

16. The method of claim 15, wherein:
the pretreating a rubber comprises:
mixing a rubber, a hydrogen peroxide, a formic acid and a surfactant to form a mixed material; and
heating and washing the mixed material.

17. The method of claim 15, wherein:
a drying temperature of the spraying and drying is about 120 to 250° C.

18. The method of claim 15, wherein:
a droplet size in the spraying and drying is about 1 to 30 μm.

19. A negative electrode comprising:
a negative electrode current collector; and
a negative active material layer formed on the negative electrode current collector,
wherein the negative active material layer comprises the composite particle according to claim 1.

20. A lithium secondary battery comprising:
the negative electrode according to claim 19;
a positive electrode opposite the negative electrode;
a separator disposed between the negative electrode and the positive electrode; and
an electrolyte.
